(19) United States
(12) Patent Application Publication
(10) Pub. No.: US 2015/0331504 A1
(43) Pub. Date: Nov. 19, 2015

(54) METHOD FOR SENSING FAST MOTION, CONTROLLER AND ELECTROMAGNETIC SENSING APPARATUS

(71) Applicant: Wacom Co., Ltd., Saitama (JP)

(72) Inventors: CHANG-HSIEN CHEN, HSINCHU COUNTY (TW); CHIH-HUNG HUANG, HSINCHU COUNTY (TW)

(21) Appl. No.: 14/472,345

(22) Filed: Aug. 28, 2014

(30) Foreign Application Priority Data
May 14, 2014 (TW) 103117014

(51) Int. Cl. G06F 3/0354; G06F 3/046

(52) U.S. Cl. CPC G06F 3/03545; G06F 3/046

(57) ABSTRACT

Disclosure is related to a method for sensing fast motion, a controller, and a related electromagnetic sensing apparatus. The method is applicable to a touch panel, in which a fast scan mode is introduced when a fast motion made by an electromagnetic stylus is sensed under a partial scan mode. Therefore, the scan mode is switched to the fast scan mode which is used to acquire coordinates of the stylus according to the electromagnetic signals generated by the stylus. After that, the process goes back to the partial scan mode for continuously sensing the location of the electromagnetic stylus, and determining any fast motion behavior. In one embodiment, in order to obtain the coordinates of the stylus when its moving rate exceeds a threshold, a moving direction may be firstly determined. The one or more sensing loops may be opened in the direction of movement.

### BACKGROUND OF THE INVENTION

1. Field of the Invention

The present invention generally relates to a method for sensing fast motion of a stylus, a control circuit, and an electromagnetic sensing apparatus, in particular, to the method, the control circuit and the apparatus able to switch scan modes under fast motion of the electromagnetic stylus for avoiding signal loss.

2. Description of Related Art

Many conventional technologies are provided to perform detection of touching location on the touch-sensitive panel. Besides the capacitance-type or resistance-type touch panel generally adapted to the handheld electronic device, a technology also exists using the sensing circuit beneath the panel to detect any sensing signal while a specific electromagnetic conductor approaches the panel. This electromagnetic panel is usually applied to the conventional input device such as digital tablet, digitizer, or electronic white board.

Regarding the conventional technology incorporating a specific electromagnetic object or finger to trigger an electromagnetic event in a touching location, a control and driving circuit is usually provided to control power supplied to the sensing circuit beneath the touch-sensitive panel to perform scanning.

The sensing circuits for the whole panel are used to sense the signals over two directions, such as X and Y axial directions. The sensing circuits of both directions are connected with the driving circuit and control circuit of the panel device. The driving circuit continuously supplies power to the sensing circuits. Every touching point upon the touch-sensitive panel is able to sense signals over the two directions. The control circuit then determines the touching location.

Thus, since every circuit loop of the sensing circuits of the touch-sensitive panel continuously scans the touching location, it needs a long charging time for charging the circuits, and also consumes power.

Moreover, it is noted that the conventional technologies fail to provide a solution to improve performance of the electromagnetic touch-sensitive panel because of the conventional electromagnetic loops may not normally react to the fast motion of the electromagnetic stylus. This means the touch panel may lose signals when the user operates the electromagnetic stylus over the touch panel at a sudden speed exceeding capability of the sensing circuit. When the touch panel fails to react to the fast motion, it may induce error of drawing or some specific functions.

### SUMMARY OF THE INVENTION

For preventing signal loss induced by the fast motion of an electromagnetic stylus over a touch panel, the present invention is generally related to a method for sensing fast motion, a control circuit, and an electromagnetic sensing apparatus. In addition to providing a scheme to switch scanning modes as sensing a fast motion, the related technology still renders high performance and power saving.

The scanning approach for touch event incorporates time-division scanning method with partial scanning policy. The partial scanning policy firstly acquires a touching location based on the result made by partial scanning. Next, the partial scanning leads to the finding out of the touching location. When a fast motion event is sensed, the system is switched to a full-area scan mode to acquire the location of the electromagnetic stylus, and then back to the normal partial scan mode. In particular, the scheme can achieve power-saving scenario since the system neither charges every loop of the panel all the time, nor always performs a scanning process over whole the panel. Further, the system may not lose performance when the system scans the touch panel in a time-division scheme with a ratio to be adjusted especially over the critical region in a high ratio.

According to one of the embodiments in accordance with the present invention, the method for sensing fast motion of the stylus mainly includes a first step of sensing an event of the electromagnetic stylus over a touch panel under a partial scan mode; a next step of entering a fast motion scan mode, and in the fast motion scan mode the coordinates of the electromagnetic stylus may be obtained by its own electromagnetic sensing signals; and a step of back to partial scan mode to obtain the location of electromagnetic stylus. Further, in the method the coordinates of electromagnetic stylus may be continuously acquired for determining if any fast motion occurs.

In the embodiment of the present invention, any fast motion is determined by judging if a displacement within a period of time (a scan period) is larger than a threshold when the electromagnetic stylus continuously moves. Furthermore, a moving direction may be determined before acquiring the coordinates of the electromagnetic stylus in the fast motion. In the meantime, one or more sensing loops of the touch panel along the moving direction are beforehand activated.

In one further embodiment, the method for sensing the fast motion may be embodied within a control circuit which is electrically connected with the touch panel.

Further, in another embodiment of the present invention, the apparatus performing the method includes the touch panel, on which the sensing lines over a first axial direction and a second axial direction are formed. The apparatus has a control circuit used to control the charging timing of the sensing lines either over the first axial direction, or over the second axial direction. A full-area scan mode, a partial scan mode, or a fast motion scan mode may be applied. The apparatus has a switch-selection circuit for turning on or off part of all of the sensing lines according to control signals.

### BRIEF DESCRIPTION OF THE DRAWINGS

FIG. 1 schematically shows a circumstance of a stylus touching a touch panel;

FIG. 2 shows a schematic diagram depicting another circumstance of the stylus touching the touch panel;

FIG. 3 shows a schematic diagram depicting the sensing circuit for the electromagnetic sensing apparatus in accordance with the present invention;

FIG. 4 shows a schematic diagram depicting the electromagnetic sensing apparatus according to one of the embodiments of the present invention;

FIG. 5 schematically describes a scanning scenario within a scan period in one embodiment of the present invention;

FIG. 6A schematically describes another scanning scenario within the scan period in one embodiment of the present invention;

FIG. 6B schematically describes one further scanning scenario in one embodiment of the present invention;

FIG. 7 schematically shows in an electromagnetic stylus in a fast motion;

FIG. 8 shows a diagram depicting the apparatus of the present invention acquiring signals made by the electromagnetic stylus;

FIG. 9 shows a flow chart depicting a method for sensing fast motion when the stylus moves over the touch panel in one embodiment of the present invention;

FIG. 10 shows a flow chart depicting the method able to handle the fast motion made by the electromagnetic stylus in one embodiment of the present invention;

FIG. 11 shows another flow chart depicting the method for handling the fast motion of the electromagnetic stylus in one embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The general handwriting touch-sensitive panel is such as digital tablet, digitizer, or electronic whiteboard. The technology for conducting input method is featured to have electromagnetic-induced or film-resistant sensing elements applied to a digital panel. The electromagnetic-induced sensing element is co-operated with a touch object which employs electromagnetic-induced technology interacted with the panel. The touch object is such as a stylus which is provided for a user to hold for handwriting easily.

The stylus provided in the disclosure is such as a handwriting device with electromagnetic circuit. The tip of stylus is the portion for touching the touch-sensitive panel. However, the types of tips may not be limited. The body of stylus is equipped with one or more buttons for launching special functions. An oscillation circuit may be installed in the body of stylus, and is used to define the frequency of electromagnetic wave.

A touch event occurs when the stylus touches the touch-sensitive panel. Since the electromagnetic-induced sensing lines sense the touch event, a triggering signal is generated. The mentioned control circuit is used to detect and compute the sensing signals that are electromagnetically induced. A signal processing unit determines a location with respect to the touch event according to the scanning result, and further determines the manipulating signals made by the stylus.

For providing a touch-sensitive panel with advantages of power saving and great performance, the present invention is related to a method for sensing fast motion, a related controller, and an electromagnetic sensing apparatus. The related touch panel respectively incorporates time-division and full-time scanning schemes in the process of scanning. The related method may effectively obtain the touching location, and further acquires the precise location under a partial scan process. The scheme saves electrical power since the process does not need to perform charging or scanning over the whole panel.

The touch panel may lose signals within a short time when the user manipulates the stylus over the panel in a fast motion. The loss may result in error determination, and the user may be required to repeat the operation for accurately locating the stylus. The method in accordance with the present invention improves the disadvantage of touch panel losing the signals when the electromagnetic stylus is in fast motion. The method for sensing fast motion applied to the electromagnetic sensing apparatus incorporates a scheme to switch its operational mode as meeting a fast motion, or in a normal state. Therefore, the scheme renders high performance and as well a power saving scenario when it provides high sensing performance.

The following description is related to the operation of the electromagnetic sensing apparatus according to the embodiments of the present invention.

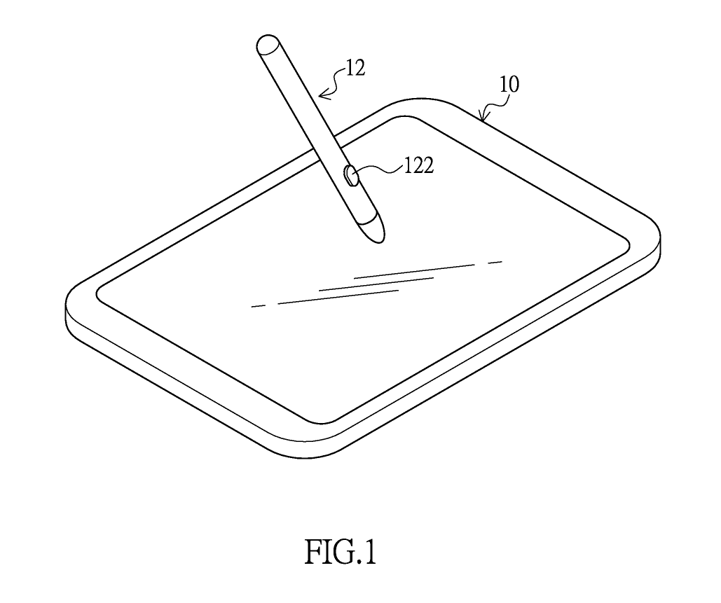

Reference is made to FIG. 1 schematically shows a circumstance that a stylus is used to input on a touch panel. A touch-sensitive panel 10 is shown. A stylus 12 is held by a hand. The stylus 12 may be equipped with a function key 122. When the user holds the stylus 12 to move above the touch-sensitive panel 10 but not contact with the panel 10, a first stage of the sensing procedure starts to be operated. A zone around the stylus 12 may be roughly detected. Next, when the stylus 12 contacts the panel 10, a touching location of the contact point made by the stylus 12 can be accurately detected because the scanning procedure may focus one limited region.

In the process of sensing the touching location, the apparatus generates a scan frequency through a timing circuit. The sensing lines within the panel then perform scanning based on this scan frequency. When the touch-sensitive panel 10 senses the input signals made by the stylus 12, a touching location may be sensed by the sensing lines over the first axial direction, e.g. X axis and over the second axial direction, e.g. Y axis of the panel. Next, with the other scan frequency, the signals made by clicking the function key 122 of the stylus 12 may be detected. Through the two scan frequencies, the touching location of the stylus 12 and the signals made by the function key 122 can be determined.

According to the circumstance shown in FIG. 1, for speeding up the responsive rate of the touch-sensitive panel, the scanning process in the method may be separated into a time-division scanning stage for a specific region, and a partial scanning mode with a full-time scanning stage. For example, the peripheral portion of the panel may be firstly scanned. The peripheral portion is over both the X and Y directions, and the scanning process may be performed over one of these directions. When any touch point is scanned within a period of scanning time, the method enters a partial scanning mode as approaching the touching point. In the scanning process, if there is not any touch point detected on the peripheral portion, the method is to scan odd or even sensing lines until the touch point is found. When the touch point is detected, the scanning process is turned to a partial zone; or the scanning is repeatedly performed over the peripheral portion over another direction (X or Y), or over the odd or even sensing lines.

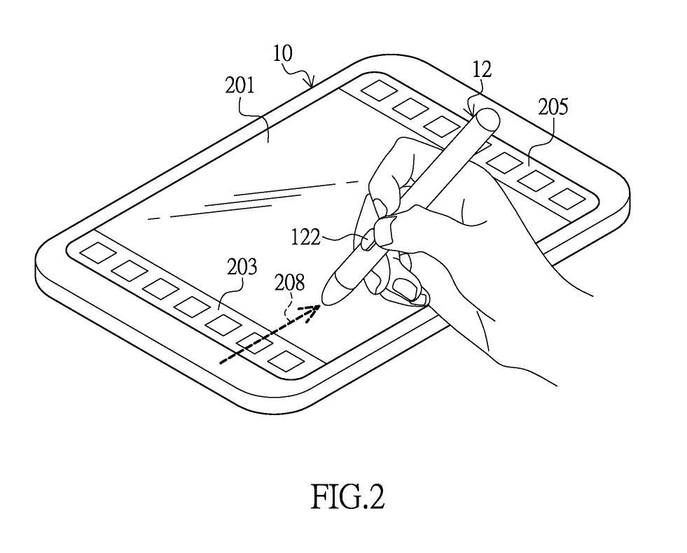

Reference is made to FIG. 2 illustrating a circumstance that the user uses a stylus to touch the panel.

A touch-sensitive panel 10 is shown. The touch-sensitive panel 10 is schematically divided into two types of panel zones (201, 203, and 205). For example, the panel zones may be divided into a work zone 201 and two function instruction zones 203, 205 that are designed over the two sides of the panel or a specific zone. The user handholds a stylus 12 equipped with a function key 122 to move above the touch-sensitive panel 10. According to normal behavior made by the user over the touch-sensitive panel 10, the method in the disclosure performs scanning according to scan timing with an operating frequency. Therefore, a time-division scanning scenario is made according to the user's behavior.

The moving direction 208 shown as the dotted line in the figure indicates the direction the stylus usually moves over the touch-sensitive apparatus. The direction appears the direction from peripheral portion to the centered work zone 201 of the touch-sensitive panel 10. In the exemplary embodiment, the moving direction 208 indicates that the user holds the stylus 12 to move from the peripheral function instruction zone 203 to the work zone 201. That means the function instruction zone 203 or 205 is the first zone for the user to choose one of the function instructions such as pen types of stylus, types of lines, line weights and colors. These function instructions render the patterns formed by the stylus 12 on the computer display connected with this touch-sensitive apparatus. After that, the stylus 12 held by the user may move toward the work zone 201 for performing handwriting or any input by the stylus 12.

It is noted that the method may focus much more on scanning over the peripheral portion since the peripheral portion of the touch-sensitive panel may be touched more frequently. The work zone 201 over the centered area of the panel may still work well even though it possibly sacrifices some performance.

To the scanning technology adapted to the touch-sensitive panel, two scanning frequencies may be applied. For example, a first frequency may be applied to scanning over the sensing loops along X axial direction. A second frequency may further be applied to scanning the sensing loops along the X axial direction. Next, the first frequency may be again applied to scanning the sensing loops along Y axial direction; and the second frequency may still be applied to scanning over the Y-axial loops. It view that the response rate may be inadequate or consume much more energy when the whole panel is scanned with both two frequencies over both two directions (X-Y), a time-division scanning scheme is introduced. According to one of the embodiments of the present invention, the time-division scanning method may be applied in the beginning. That means sensing the touch event over the function instruction zone 203 or 205 may have higher priority. While a triggering zone indicative of a location with respect to the touch event according to the scanning result is determined, the next scanning task is then performed over this triggering zone.

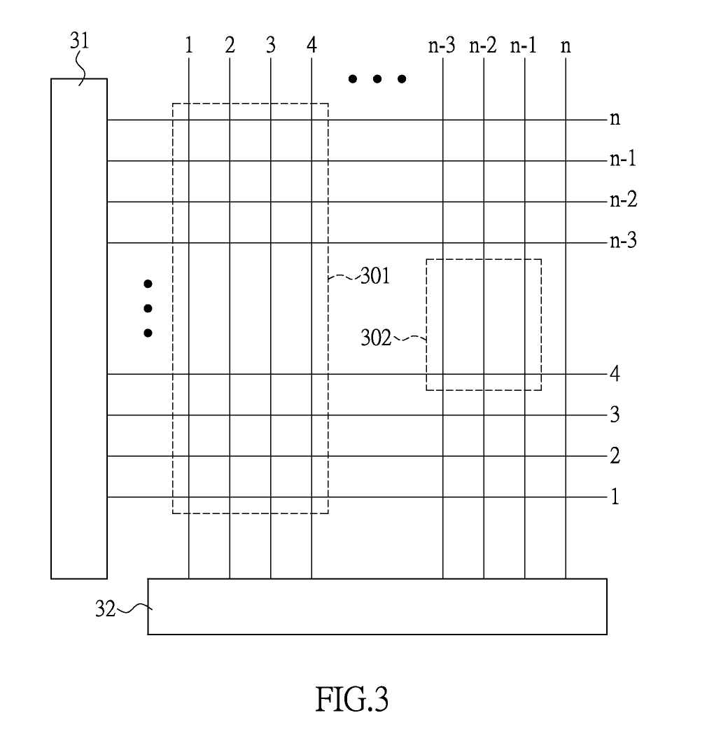

Reference is made to FIG. 3 schematically depicting the electromagnetic sensing apparatus utilizing the method for sensing the fast motion according to one embodiment of the present invention.

The sensing lines 1, 2, 3, 4 . . . n-3, n-2, n-1 and n over the at least two directions schematically are shown in the figure. The crisscross sensing lines 1, 2, 3, 4 . . . n-3, n-2, n-1 and n over the touch panel are used to sense any touch event over the at least two directions. In the present embodiment, a first driving circuit 31 and a second driving circuit 32 associated to the sensing lines are disposed. A control circuit is further incorporated to control the first driving circuit 31 and the second driving circuit 32 respectively driven to electrically charge the sensing lines according to a scan timing scenario. The powered sensing lines are used to acquire any touching signal.

In the diagram, a side area circled by the dotted square indicates a first sensing region 301, and a centered area circled by the other dotted square is a second sensing region 302. According to the property of the panel, the time-division scanning scheme is performed over the first sensing region 301 with more scanning time. The relatively less scanning time is for the second sensing region 302. While a triggering zone is determined, the further full-time scanning scheme is performed upon the triggering zone. The full-time scanning scheme employs a partial scanning mode over the triggering zone. Further, the precise location of the any touch event can be obtained.

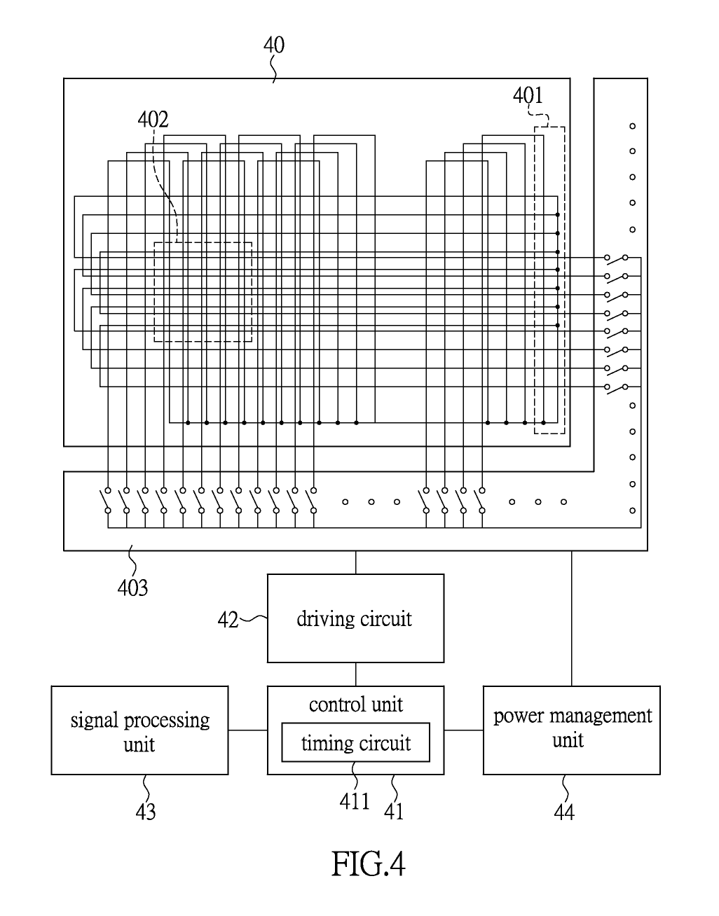

FIG. 4 shows a schematic diagram depicting the circuits of the electromagnetic sensing apparatus in one embodiment of the touch-sensitive apparatus. Many loops of the sensing lines are provided over the touch-sensitive panel 40. The sensing lines over at least two directions are such as sensing lines along the first axial direction and sensing lines along the second axial direction. However, the figure shows the schematic diagram of the loops of sensing lines but not the practical implementation.

The touch-sensitive apparatus has a control circuit electrically connected with the touch-sensitive panel 40. The control circuit is such an integrated chip (IC) to process the fast motion signals while it is in charge of controlling the charging timing for the sensing lines over the first axial direction and the second axial direction. According to the scenario of charging timing, the time-division and full-time scanning are performed. In the present embodiment, based on the functions the invention performs, the control circuit may include a control unit 41, a driving circuit 42, a signal processing unit 43, and a power management unit 44. According to scan frequency and time-division scanning based on the scanning scenario made by the present invention, the driving circuit 42, is driven by the control unit 41. The driving circuit 42 also drives a switch-selection circuit 403. The switch-selection circuit 403 is electrically connected with the control circuit, and also connected with the sensing lines along both the first axial direction and the second axial direction. The switch-selection circuit 403 is driven to turn on or turn off the part of all of the sensing lines according to a control signal generated by the control circuit.

The driving circuit 42 may then charge the sensing lines according to the loops on or off made by the switch-selection circuit 403. The turned-on or off loops are configured to scan the touching signals. A power management unit 44 is controlled by the control unit 41. The power management unit 44 is used to manage the electric power supplied to the sensing lines of the touch-sensitive panel 40. For example, the power management unit 44 selectively powers the sensing lines of the panel 40 through the switch-selection circuit 43 driven by the driving circuit 42.

The control unit 41 includes a timing circuit 411. The timing circuit 411 generates one or more timing signals. The timing circuit 411 is configured to render one or more scan frequencies according to the various triggering events. The control unit 41 conducts the scanning according to the timing signal so as to control the scanning timing. A scanning result may be generated in association with the various locations and frequencies while a signal processing unit 43 electrically connected with the control unit 41 processes the signals. In which, the signal processing unit 43 processes the sensing signals generated from the sensing lines over the first axial direction and the second axial direction so as to determine the triggering zone or a location related to the touch event. Further, the control unit 41 drives the full-time scanning process over the triggering zone. The output made by the signal processing unit 43 includes a touch point made by the touch object, and further confirming an operating frequency with respect to the touch event so as to determine the triggering event. The triggering event is such as functionality triggered by the touch event. The present invention uses the scan frequency to conduct the touch scanning.

In the method in accordance with the present invention, the control circuit of the panel is essentially used to conduct the scanning strategy, including performing partial scanning with one or more frequencies. With various frequencies, the system switches scanning modes for the fast motion, especially preventing losing signals made by the fast moving stylus. The time-division scanning scheme provides a solution for power saving and maintaining a great performance. In addition to the above-described circuits, the specification of the present invention does not give necessary details of other necessary circuits such as amplifier, filter, signal converter, and any driving circuit.

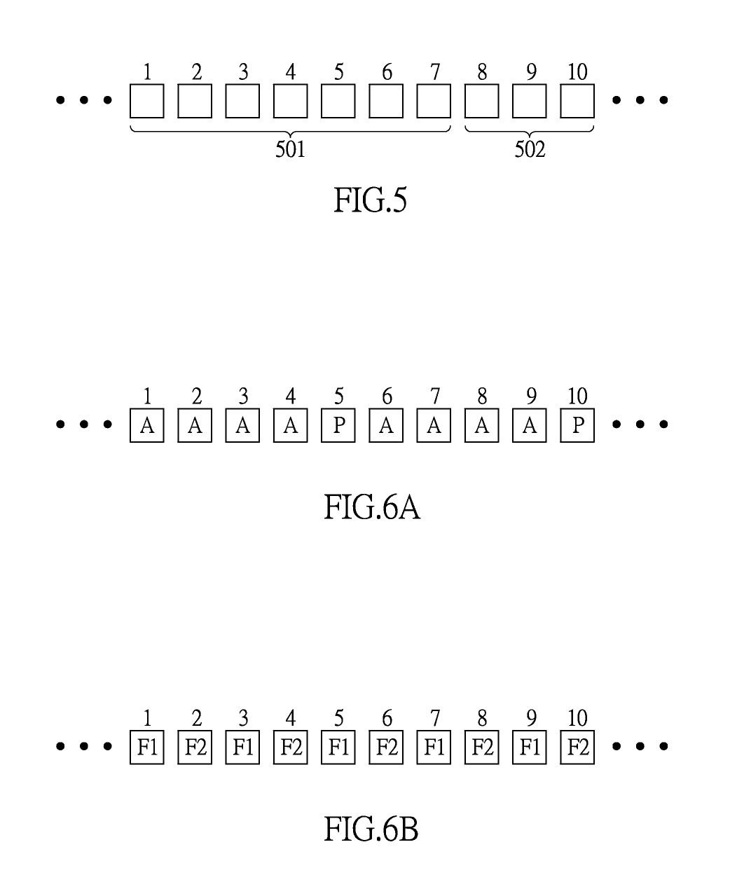

The control circuit of touch panel controls the scanning as charging the sensing loops. Normally, most of the time the edges around the panel are scanned when the electromagnetic stylus is not sensed over the panel. It is noted that, in general, the electromagnetic-type touch panel includes at least one functional zone positioned at the left, right, top, or bottom side of the touch panel. The mentioned four sides of the panel are scanned because the panel may be allowed to be functioned rotationally. Some other time the odd or even loops in the shorter direction are charged to be scanned. Those exemplary scanned zones are, depicted in FIG. 5 in view of the embodiment of FIG. 6A, such as a first sensing region and a second sensing region.

A time-division scanning mode is therefore provided to scan the whole touch panel, such as FIG. 5 showing a schematic diagram depicting the scanning scenario within a scan period according to one embodiment of the present invention.

The shown scan timing indicates a ratio of allocating the first sensing region and the second sensing region within a scan period. That means different tasks are configured within this scan period according to the scan timing scenario. For example, the first sensing region indicates a function instruction zone of the touch-sensitive apparatus; the second sensing region may be a work zone, or a region including both the function instruction zone and work zone of the touch-sensitive apparatus. The mentioned first sensing region, second sensing region, or any triggering zone may be formed within a zone surrounding part or all of the sensing lines along the different axial directions, such as the part or all sensing lines along the first axial direction and second axial direction. Therefore, according to the scanning strategy, the time-division or full-time scanning may be performed by sequentially charging part or all the sensing lines along the first axial direction and the second axial direction.

In one embodiment of the present invention, the control circuit is configured to provide a scan timing configuration. The configuration includes a ratio of allocating the scanning zones. For example, the ratio of the allocation includes a partial scanning zone with 80% of the region and remaining zone with 20% of the region.

As shown in the diagram, in first time 501, the scanning method is performed over a specific panel zone based on the configuration. The first time 501 obviously occupies a longer time of the scan timing; and the second time 502 is shorter time. The scan timing can be dynamically configured for the various scanning tasks according to the practical requirement and design.

In an exemplary embodiment of the present invention, the touch-sensitive panel performs a partial scanning over the function instruction zone within the first time 501; a full-panel scanning may be performed within the second time 502; or the scanning task is over the remaining zone such as the zone excluding the function instruction zone. A partial scanning is performed within the first time 501. Another partial scanning may also be performed within the second time 502, but not for charging or scanning over the whole panel. The time-division scanning scheme introduced into the present invention achieves power saving.

It is worth noting that, in one embodiment for the purpose of power saving, the scanning process may be orderly performed for the odd sensing lines and the even sensing lines separately according to the timing configuration.

Reference is made to FIG. 6A schematically depicting the scanning scenario within a scan period.

Within the scan period, scan timing may be configured to adapt to a peripheral zone A and panel zone P, e.g. the central portion, of the touch-sensitive panel. In the present example, the scan period is divided into 10 timing periods. The control circuit performs electric charging to the sensing loops over a peripheral zone A in the timing periods 1-4 and 6-9. The charging to the sensing loops over the panel zone P is performed in the timing periods 5 and 10. The panel zone P may include the zone excluding the peripheral zone A, but may also be the zone over the whole panel.

When the system finds the electromagnetic stylus, reference is made to the description of FIG. 6B, and the system enters a partial scan mode. Under the partial scan mode, two types of scanning frequencies are introduced. The regular movement of the stylus can be resolved through the two types of scanning frequencies, including acquiring the location and operational instructions. In particular, for preventing losing the moving signals, the system is required to moreover initiate one or more sensing loops along a moving direction of the electromagnetic stylus.

FIG. 6B schematically shows the operating frequencies within a scan period according to a scanning strategy.

If a touch-sensitive panel is configured to be operated with two scan frequencies, scan timing with different frequencies within a scan period may be provided. For example, the method performs scanning with a first frequency F1 and a second frequency F2 within the scan period orderly. The first timing shows a touch signal is scanned with a first frequency, and the second timing shows another touch signal with a second frequency. In practice, the scan timing configured for the first frequency F1 and the second frequency F2 may occupy different proportions.

Next, the method for sensing the fast motion made is generally adapted either to the electromagnetic stylus, or to the electromagnetic sensing apparatus using the stylus. One of the objectives of the method is to avoid signal loss when the electromagnetic stylus fast moves. The fast motion is such as the behavior of the stylus held by the user quickly moves as in normal state. Meanwhile, the method swiftly switches the scanning mode in response to the fast motion.

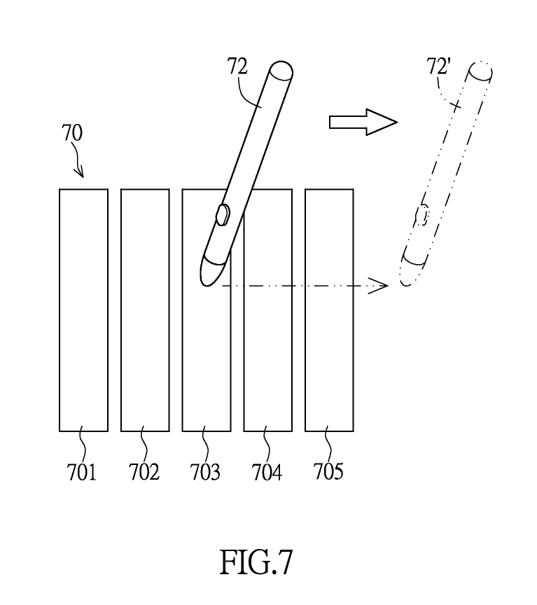

Reference is made to FIG. 7 schematically showing the electromagnetic stylus in fast motion over a touch panel 70. Another electromagnetic stylus 72′ exemplarily shows the next position of the electromagnetic stylus 72.

On the touch panel 70, it shows several sensing loops 701, 702, 703, 704, and 705 around the location of electromagnetic stylus 72 are turned on for responding the movement of stylus 72. When the electromagnetic stylus 72 swiftly moves and becomes the electromagnetic stylus 72′, the control circuit of touch panel 70 may lose the signals of the fast motion.

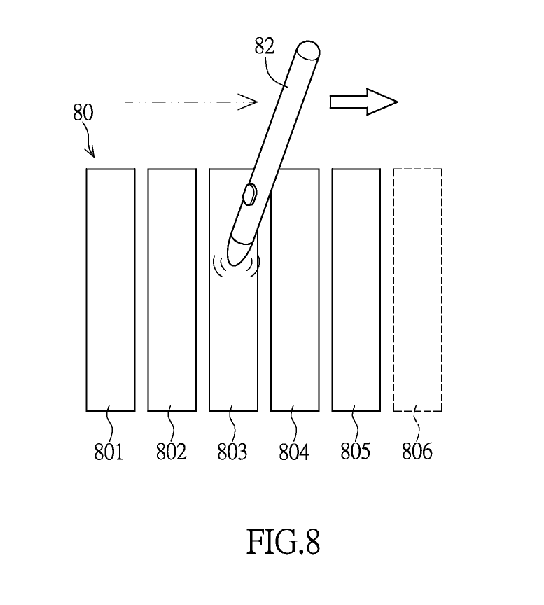

FIG. 8 shows a schematic diagram depicting the electromagnetic sensing apparatus accurately finding the location of the electromagnetic stylus when it generates its own electromagnetic sensing signals.

In the current exemplary embodiment, the scan mode of the touch panel 80 is switched to a fast motion scan mode when acknowledging the electromagnetic stylus 82 is in fast motion. In the meantime, the sensing loops 801, 802, 803, 804, and 805 over the touch panel 80 are activated to find out the location of electromagnetic stylus 82 in response to the electromagnetic sensing signals made by the stylus 82. Further, the active sensing loops toward the moving direction of the electromagnetic stylus 82 may be added, for example the sensing loop 806.

When the touch panel obtains the location of electromagnetic stylus by the loops sensing the stylus's electromagnetic sensing signals in the fast motion scan mode, the electromagnetic sensing signals are instantaneously the greatest signals over the whole touch panel.

That means the system of the touch panel temporarily enters the fast motion scan mode when the control circuit fails to correctly locate the electromagnetic stylus as the moving speed exceeds a predetermined threshold. Therefore the system in the fast motion scan mode finds out the greatest power over the whole touch panel. A moving direction of the stylus is also calculated according to a displacement. After that, the system enters a partial scan mode, and one or more sensing loops of the touch panel along the moving direction are beforehand activated.

Furthermore, the added sensing loops along the moving direction may be over both two axial directions (X, Y) when the movement is in an oblique direction. The more sensing loops along X direction may be activated in response to the X-directional movement; and similarly the more sensing loops along Y direction may be activated in response to the Y-directional movement.

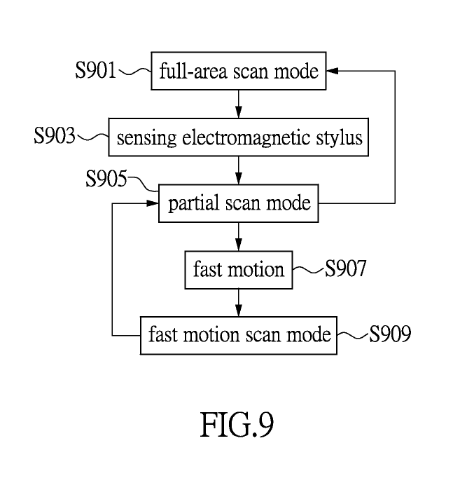

FIG. 9 shows the method for sensing fast motion according to one embodiment in accordance with the present invention. The system will be in different scan modes according to a scanning scenario for preventing signal loss when the electromagnetic stylus swiftly moves over the touch panel.

In the beginning of the method, such as in step S901, the system enters a full-area scan mode. The system performs a time-division scanning for scanning the different zones according to a scan timing configuration under the full-area scan mode. The full-area scan mode using the time-division scanning is activated when the system finds no behavior made by the electromagnetic stylus. Under this full-area scan mode, most of the time the system scans the edges around the touch panel in one scan timing. The time-division scanning means the system alternately scans the odd sensing lines or even sensing lines in one scan timing until locating the electromagnetic stylus, such as step S903.

When the behavior of electromagnetic stylus is acknowledged using the time-division scanning scenario, a triggering zone can be roughly obtained. In the meantime, such as in step S905, the system enters a partial scan mode when acknowledging the electromagnetic stylus approaching the triggering zone of the touch panel. Therefore, in next step, the system partially scans the triggering zone, and simultaneously activates the sensing lines around the triggering zone for locating the electromagnetic stylus. In a normal state, the system under the partial scan mode can continuously locate the electromagnetic stylus as moving over the touch panel, and execute the related instruction in response to the action of the electromagnetic stylus. When the electromagnetic stylus leaves the touch panel, the system enters the full-area scan mode and the process goes back to step S901.

When the system acknowledges the electromagnetic stylus in a fast motion toward a moving direction, such as step S907, the system enters the fast motion scan mode in step S909 since it may fail to accurately locate the stylus. Under this fast motion scan mode, the system locates the electromagnetic stylus in response to the electromagnetic sensing signals made by the electromagnetic stylus. For example, the electromagnetic sensing signals made by the stylus may be the greatest signals over the touch panel, and allow the system to locate the stylus. The system then enters a partial scan mode for standby sensing any touch event made by the electromagnetic stylus when the process goes back to step S905.

In particular, a gain control mechanism may be introduced when the system continuously obtains the signals of sensing lines under the various scan modes. The gain control mechanism is introduced to adjusting (amplifying) the sensing signals for conveniently sensing the electromagnetic sensing signals of the electromagnetic stylus.

It is noted that, according to one of the embodiments, for fast acquiring the sensing signals of the electromagnetic sensing apparatus and locating the stylus, a signal amplification circuit of the touch panel incorporates a gain control mechanism for non-incrementally adjusting gain. The non-incremental gain adjustment may converge the value quickly rather than the conventional gain control method which gradually adjusts the gain. The gain control mechanism may fast converge the output to suitable signals by obtaining a suitable gain which is such as a magnification for a driving voltage. Therefore, the gain control mechanism may suitably adjust the gain when the output signals are too large. The conventional gain control may also be involved to adjust the normal signals. In an exemplary example, the gain control mechanism is such as a binary tree gain computation for fast adjusting gain value. For example, an original gain 50 dB is adjusted to be 100 dB. The binary tree gain computation finds the gain as 75 which may be employed to amplify gain value for finding out a preliminary sensing zone. After that, within the sensing zone, the conventional gain control is to fine tune the signals.

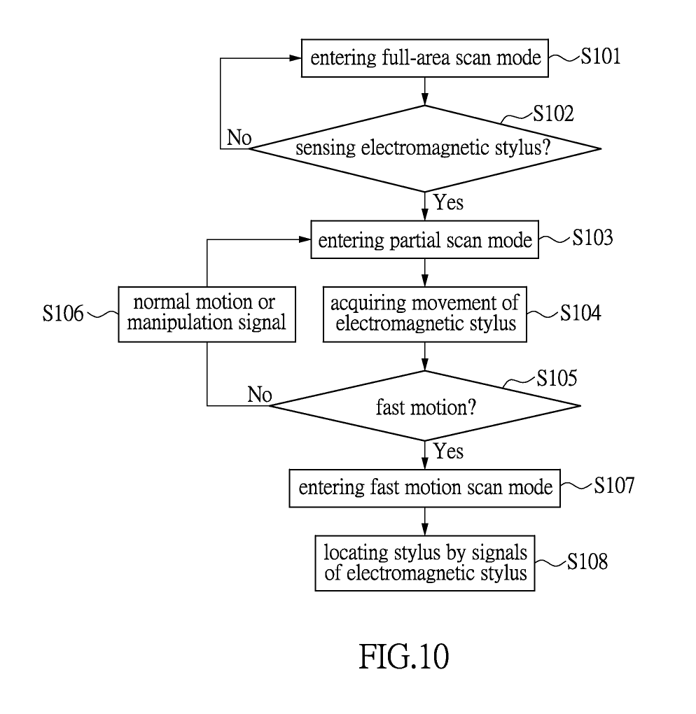

The flow chart shown in FIG. 10 is to describe the method for sensing fast motion made by the electromagnetic stylus in one embodiment of the present invention.

In the beginning, such as step S101, the system enters a full-area scan mode for scanning the whole touch panel, in particular incorporating a time-division scanning scenario in consideration of requirements of power saving and fast reaction. The time-division scanning is performed onto the sensing lines over the first axial direction or second axial direction.

Next, in step S102, the system determines if any event made by the electromagnetic stylus is sensed. The process will be in the original scan mode in step S 101 if there is no event to be sensed. On the contrary, the system enters a partial scan mode in step S103 if finding out the electromagnetic stylus entering a sensing zone. Under the partial scan mode, the system will activate more sensing loops for the triggering zone where the electromagnetic stylus is located. In the meantime, any moving signal of the electromagnetic stylus is sensed, such as step S104.

When the system continuously acquires the moving signals of the electromagnetic stylus under this partial scan mode, the system records the coordinates when the electromagnetic stylus moves constantly for a period of time. A displacement is then computed by computing the plurality of continuous coordinates of the electromagnetic stylus. These records may be used to determine any fast motion within the period of time, such as step S105. According to one embodiment, the sets of coordinates of the electromagnetic stylus renders a displacement within the time and the displacement compared to a threshold is used to determine any fast motion.

When the displacement is smaller than the threshold, it is determined that the movement is under a normal manipulation, such as step S106, the system may still continuously receive the moving signals or manipulation signals from the electromagnetic sensing apparatus. The process then goes back to step S103.

However, any fast motion made by the electromagnetic stylus may be verified under the partial scan mode if the displacement within a period of time is larger than the threshold. Such as step S107, the system of touch panel enters a fast motion scan mode.

Under this fast motion scan mode, such as step S108, the system obtains the coordinates of the electromagnetic stylus by computing the electromagnetic sensing signals generated by the electromagnetic stylus. The process may afterwards go back to step S103 and the system enters the partial scan mode for continuously sensing the touch event including the fast motion made by the electromagnetic stylus.

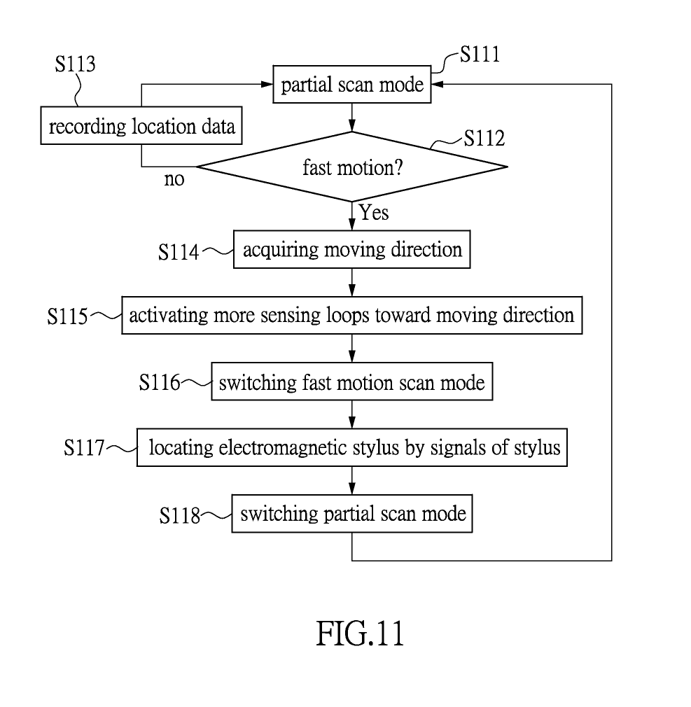

FIG. 11 moreover shows a flow chart depicting the process when the system enters the fast motion scan mode according to one of the embodiments.

When the electromagnetic stylus moves over the touch panel, such as step S111 showing a normal state when the system is under a partial scan mode. The system therefore is able to sense the normal movement of the electromagnetic stylus, and receive the manipulation signals via various scanning frequencies. The coordinates of the electromagnetic stylus for every moment may still be recorded. A displacement within the period may be computed for determining any fast motion, such step S112.

If there is not any fast motion event occurred, such as step S113, the system continuously records the locations of the electromagnetic stylus. These data are used to determine the fast motion. A fast motion event is found as the system acknowledges the instant displacement is larger than a threshold. Such as step S114, a moving direction may be determined under normal state or in the fast motion. In the meantime, one or more sensing loops may be activated toward the moving direction, such as step S115. It is noted that the at least one activated sensing loop for the fast motion sensing may effectively avoid signal loss because the signals of fast motion of the electromagnetic stylus may not strong enough to be sensed.

The system then enters the fast motion scan mode when sensing the fast motion, such as step S116. Next, such as step S117, the system locates the electromagnetic stylus through its generated electromagnetic sensing signals which are the strongest signals over the whole touch panel. The process may be switched back to the partial scan mode, such as steps S118 and S111, for the normal operation. At this moment, in one embodiment of the present invention, one or more sensing loops may be activated toward the moving direction.

To sum up, according to the above embodiments of the present invention, the method, control circuit, and the related electromagnetic sensing apparatus are provided. The main idea is to provide the various scanning scenarios in response to different situations. Firstly, the time-division scanning is performed onto the partial zones. The full-time scanning is then performed when the system acknowledging any signal made by the stylus. This approach can swiftly react to any touch event as well maintain performance and achieve power saving. In the moment of sensing fast motion of the electromagnetic stylus, the fast motion scan mode for the system is able to accurately locate the electromagnetic stylus without losing signals.

It is intended that the specification and depicted embodiment be considered exemplary only, with a true scope of the invention being determined by the broad meaning of the following claims.

What is claimed is:

1. A method for sensing fast motion of an electromagnetic stylus adapted to a touch panel, comprising:
entering a fast motion scan mode as sensing a fast motion of the electromagnetic stylus when the touch panel is under a partial scan mode;
under the fast motion scan mode, acquiring a location of the electromagnetic stylus in response to electromagnetic sensing signal generated by the electromagnetic stylus; and
back to the partial scan mode, continuously determining any fast motion of the electromagnetic stylus by locating the electromagnetic stylus.

2. The method according to claim 1, wherein the electromagnetic stylus is determined as in the fast motion when a displacement, which is continuous change of coordinates, of the electromagnetic stylus within a scan period is larger than a threshold under the partial scan mode.

3. The method according to claim 2, wherein the displacement is computed by recording a plurality of continuous coordinates of the electromagnetic stylus within the scan period.

4. The method according to claim 3, wherein, before acquiring the coordinates of the electromagnetic stylus in the fast motion, a moving direction is determined according to the displacement, and one or more sensing loops of the touch panel along the moving direction are beforehand activated.

5. The method according to claim 4, wherein, a gain control mechanism is introduced to amplify the sensing signals when sensing coordinates of the electromagnetic stylus for successfully sensing electromagnetic sensing signals of the electromagnetic stylus.

6. The method according to claim 5, wherein the gain control mechanism includes a binary tree gain computation for fast adjusting gain value.

7. The method according to claim 1, wherein the touch panel includes a first sensing region and a second sensing region, and the step of sensing the location of the touch panel touched by the electromagnetic stylus comprises:
in accordance with a scan timing scenario, scanning the first sensing region and the second sensing region by a time-division scheme; wherein the scan timing scenario includes allocation of a ratio of scanning the first sensing region and the second sensing region within a scan period;
acquiring a triggering zone according to a result of scanning;
performing a full-time scanning upon the triggering zone; and
determining the location of the electromagnetic stylus according to the result of scanning.

8. The method of claim 7, wherein the step of scanning the first sensing region and the second sensing region is performed by charging sensing lines within the first sensing region and the second sensing region of the touch-sensitive apparatus according to the scan timing scenario.

9. The method according to claim 8, when the touching location of the electromagnetic stylus is determined, further comprising:
verifying an operating frequency for sensing the touching location, and the operating frequency corresponding to the touch event; and
verifying the touch event in response to the operating frequency.

10. The method according to claim 9, wherein the first sensing region corresponds to a function instruction zone of the touch panel; the second sensing region corresponds to a work zone of the touch panel, or a zone including the function instruction zone and the work zone.

11. A control circuit performing the method for sensing fast motion of the electromagnetic stylus according to claim 1, wherein the control circuit is electrically connected with the touch panel.

12. An electromagnetic sensing apparatus performing the method for sensing fast motion of the electromagnetic stylus, wherein the electromagnetic sensing apparatus comprises:
the touch panel, having sensing lines along a first axial direction and another sensing lines along a second axial direction;
a control circuit, electrically connected with the touch panel, used to control timing for charging the sensing lines along the first axial direction and the sensing lines along the second axial direction under a full-area scan mode, the partial scan mode, or the fast motion scan mode; and
a switch-selection circuit, electrically connected with the control circuit, the sensing lines along the first axial direction, and the sensing lines along the second axial direction, and used to turn on or turn off part or all the sensing lines along the different axial directions in response to a control signal of the control circuit.

13. The apparatus according to claim 12, wherein the control circuit includes a driving circuit used to drive the sensing lines in the touch panel to be turned on or turned off; the driving circuit selectively charges the sensing lines via the switch-selection circuit.

14. The apparatus according to claim 13, wherein the control circuit includes the sensing lines along the first axial direction and the sensing lines along the second axial direction; a signal processing unit is included in the apparatus to determine the location of the triggering zone or a touch event according to the sensing signals generated by the sensing lines.

15. The apparatus according to claim 12, wherein, under the full-area scan mode, a time-division scanning method is performed on the sensing lines respectively over the first axial direction or the second axial direction.
